(19) United States
(12) Patent Application Publication
(10) Pub. No.: US 2007/0095362 A1
(43) Pub. Date: May 3, 2007

(54) Brush and method

(76) Inventor: Samar Asefi Koopah, Lafayette, CA (US)

Correspondence Address: John W. Carpenter Esq, Suite 707, 405 Davis Ct., San Francisco, CA, 94111, US

(21) Appl. No.: 11/429,389

(22) Filed: May 5, 2006

Related U.S. Application Data
(60) Provisional application No. 60/730,990, filed on Oct. 28, 2005.

(51) Int. Cl. B08B 3/12

(52) U.S. Cl. 134/1; 134/58 R

(57) ABSTRACT

A method for washing comprising providing an electrical vibrating device having a handle assembly coupled to a detachable head assembly, and dispensing at least one fluid from the head assembly for washing. An electrical vibrating device having a handle assembly coupled to a detachable head assembly. The head assembly includes a body, and a face secured to the body and having at least one dispensing cone assembly for dispensing fluid.

### CROSS-REFERENCE TO RELATED APPLICATIONS

This patent application is related to Provisional Patent Application having application No. 60/730,990, filed Oct. 28, 2005, and fully incorporated herein by reference thereto as if repeated verbatim immediately herein. Benefit of the Oct. 28, 2005 filing date for the Provisional Patent Application is claimed.

### FIELD OF THE INVENTION

Embodiments of the present invention are related to a brush and method. More specifically, embodiments of the present invention provide an electrical hair brush and/or body washer, and method for washing.

### BACKGROUND OF THE INVENTION

Numerous hair and body washing electrical devices exist on the market. However, these devices do not provide the convenience of readily dispensing a plurality of fluids, particularly dispensing while simultaneously controlling the quantity of the plurality of fluids being dispensed.

### SUMMARY OF EMBODIMENTS OF THE INVENTION

Embodiments of the present invention provide a method for washing comprising providing an electrical vibrating device having a handle assembly coupled to a detachable head assembly, and dispensing at least one fluid from the head assembly for washing.

Embodiments of the present invention also provide an electrical vibrating device having a handle assembly coupled to a detachable head assembly. The head assembly includes a body, and a face secured to the body and having at least one dispensing cone assembly for dispensing fluid.

These provisions, together with the various ancillary provisions and features which will become apparent to those skilled in the art as the following description proceeds, are attained by the methods and assemblies of the present invention.

### BRIEF DESCRIPTION OF THE DRAWINGS

FIG. 1 is a perspective view of an embodiment of the electrical hair brush and/or body washer.

FIG. 2 is a perspective view of an embodiment of the head of a body massager.

FIG. 3 is a side elevational view of another embodiment of the head of a body massager, illustrating an arcuate shaped configuration.

FIG. 4 is an elevational view of another embodiment of the head of a body massager.

FIG. 5A is a partial side sectional view of an embodiment of a dispensing cone assembly located in and/or on the head of the electrical hair brush and/or body washer.

FIG. 5B is a partial side sectional view of another embodiment of the dispensing cone assembly located in and/or on the head of the electrical hair brush and/or body washer.

FIG. 5C is a partial side sectional view of yet another embodiment of the dispensing cone assembly located in and/or on the head of the electrical hair brush and/or body washer.

FIG. 6A is a top plan view of an embodiment of the electrical hair brush and/or body washer, illustrating in dotted representation an electrical head vibrating assembly for vibrating and/or partial moving back and forth (like an electrical tooth brush) the head assembly of the electrical hair brush and/or body washer.

FIG. 6B is a top plan view of another embodiment of the head assembly of the electrical hair brush and/or body washer.

FIG. 6C is a top plan view of the embodiment of the head assembly of the electrical hair brush and/or body washer in FIG. 6B after the two compartment covers have been respectively removed from and/or off of the two compartments, exposing the insides of the two compartments including a plurality of holes or fluid dispensing cone assemblies where through fluid from the compartments exits.

FIG. 7 is a top plan view of an embodiment of a fluid bag with the adhesive member pulled away and off of the plurality of holes where fluid exits the fluid bag.

FIG. 8 is a top plan view of another embodiment of a fluid bag with the flap member having been pulled away and off of the adhesive member which has a hole where fluid exits the fluid bag.

FIG. 9 is a side elevational view of the embodiment of the fluid bag in FIG. 8.

FIG. 10 is a top plan view of the embodiment of the head assembly of the electrical hair brush and/or body washer in FIG. 6B after the two compartment covers have been respectively removed from and/or off of the two compartments, exposing a fluid bag respectively disposed in each of the two compartments.

FIG. 11 is a vertical sectional view taken in direction of the arrows along the plane of line 11-11 in FIG. 10 showing the adhesive member of a fluid bag engaged to and/or around a fluid dispensing cone assembly, so that after the flap member has been pulled off and/or away from the adhesive member, fluid from the bag may flow from the fluid bag and through the fluid dispensing cone assembly and into a well or cavern communicating with a plurality of dispensing apertures.

FIG. 12 is a vertical sectional view taken in direction of the arrows along the plane of line 12-12 in FIG. 6B.

FIG. 13 is a vertical sectional view taken in direction of the arrows along the plane of line 13-13 in FIG. 6C.

FIG. 14 is a sectional view of another embodiment of the head assembly of the electrical hair brush and/or body washer illustrating part of the wiring assembly engaged to a valve in each of the fluid dispensing cone assembly to control the flow of fluid from each of the compartments and through each the fluid dispensing cone assemblies.

FIG. 15 is a sectional view of another embodiment of the head assembly of the electrical hair brush and/or body washer, illustrating part of the wiring assembly of the electrical head vibrating assembly, disposed underneath each of the compartments and passing around each the fluid dispensing cone assemblies, to assist in the vibrating and/or partial moving back and forth (like an electrical tooth brush) of the head assembly of the electrical hair brush and/or body washer.

FIG. 16 is a partial side elevational view of the head assembly illustrating the face flexibly joined to the body of the head assembly so that only the face vibrates and/or partially moves back and forth.

### DETAILED DESCRIPTION OF THE EMBODIMENTS OF THE INVENTION

In the description herein, numerous specific details are provided, such as examples of components and/or methods, to provide a thorough understanding of the embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of the embodiments of the present invention.

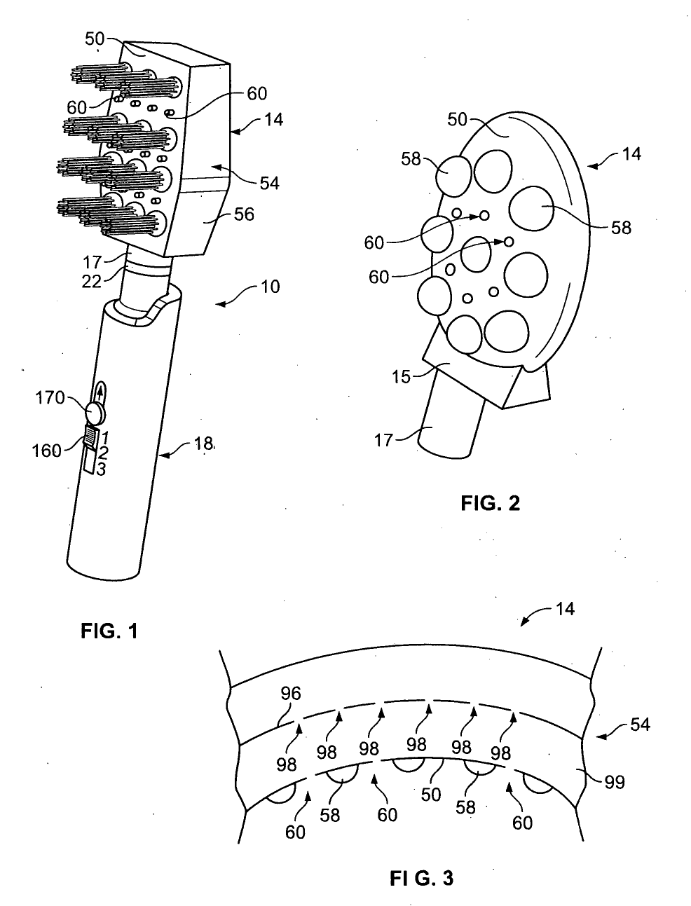

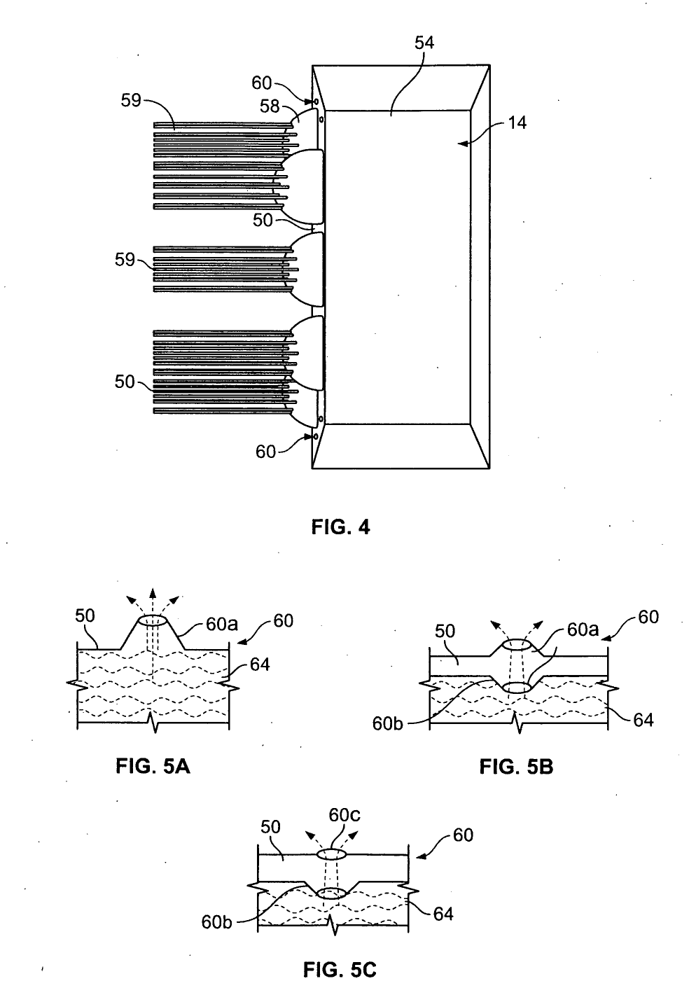

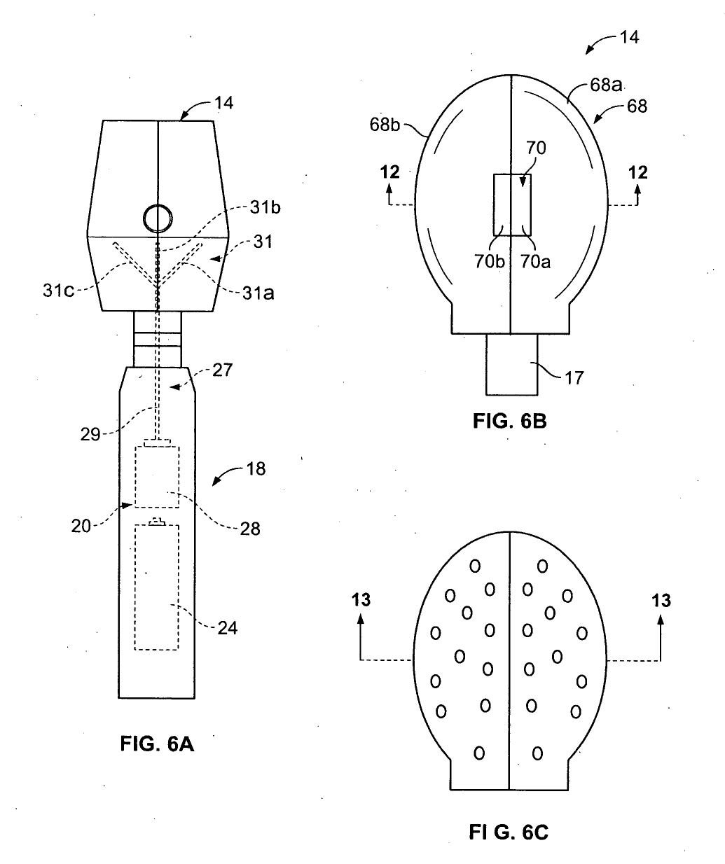

Referring in detail now to the drawings, there is seen in FIG. 1 a perspective view of an embodiment of the electrical brush and/or body washer, generally illustrated as 10. The electrical brush and/or body washer 10 includes a detachable head assembly, generally illustrated as 14, and a handle assembly, generally illustrated as 18. The head assembly 14 is detachable from the handle assembly 18 at releasing joint 22. The electrical brush and/or body washer 10 includes an electrical head vibrating assembly, generally illustrated as 20, as best shown FIG. 6A which is a top plan view of an embodiment of the electrical hair brush and/or body washer 10, illustrating in dotted representation an electrical head vibrating assembly 20 for vibrating and/or partial moving back and forth (like an electrical tooth brush) the head assembly 10 of the electrical hair brush and/or body washer 10. It is to be understood that the electrical head vibrating assembly 20 does not necessarily have to vibrate and/or partial move back and forth the entire head assembly 10. The spirit and scope of the present invention includes vibrating and/or partial moving back and forth a portion of the head assembly 10, such as the face (identified below as “50” below) when flexibly secured to the body (identified below as “54” below) of the head assembly 10, as best show in FIG. 16 which is a partial side elevational view of the head assembly 10 illustrating the face flexibly joined to the body of the head assembly 10 so that only the face vibrates and/or partially moves back and forth.

The handle assembly 18 includes a motor 28 coupled to a rechargeable battery 24 and to a linkage assembly 27 which couples to a coupling rod 29. A fluctuating assembly 31 is coupled to the coupling rod 29. The fluctuating assembly 31 includes fluctuating fingers 31a, 31b, and 31c. The fluctuating assembly 31 (including fluctuating fingers 31a, 31b, and 31c) may vibrate and/or move the entire head 14, or the fluctuating assembly 14 may be disposed such as to only vibrate and/or move a face 50 flexibly coupled to a hollow body 54 at flexible structure 55 (as best shown in FIG. 16). Depending from the face 50 are nubs or knobs 58 which may support bristles 59. In other embodiments of the inventions (see FIG. 2), the knobs 58 may assist in massaging functions or actions, and does not necessarily have to support any bristles 59. The head assembly 14 may include a base 15 supporting a depending neck 17 which may be coupled to the hand assembly 18 by any suitable means, such as by the releasing joint 22.

The electrical head vibrating assembly 20 for vibrating and/or partial moving back and forth (like an electrical tooth brush) the head assembly 14 (or the face 50) of the electrical brush and/or body washer 10 may be any suitable electrical head vibrating assembly, such as that sold by Phillips Oral Healthcare, Inc. of Snoqualmie, Wash. 98065 in any of the Advance 4000 series sonic toothbrushes. These toothbrushes include a rechargeable battery, such as the battery 24 of the electrical head vibrating assembly 20. A charger base (not shown) is provided and includes a cord (not shown) which is plugged into an outlet for receiving current for recharging the battery. The electrical brush and/or body washer 10 of the present invention may also have a charger base and a cord for recharging the battery 24.

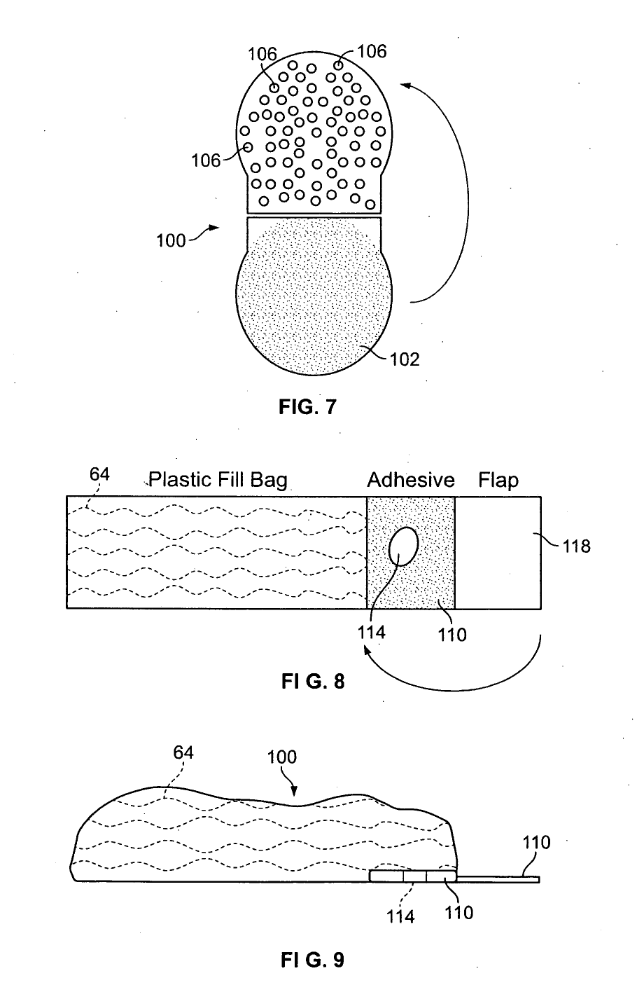

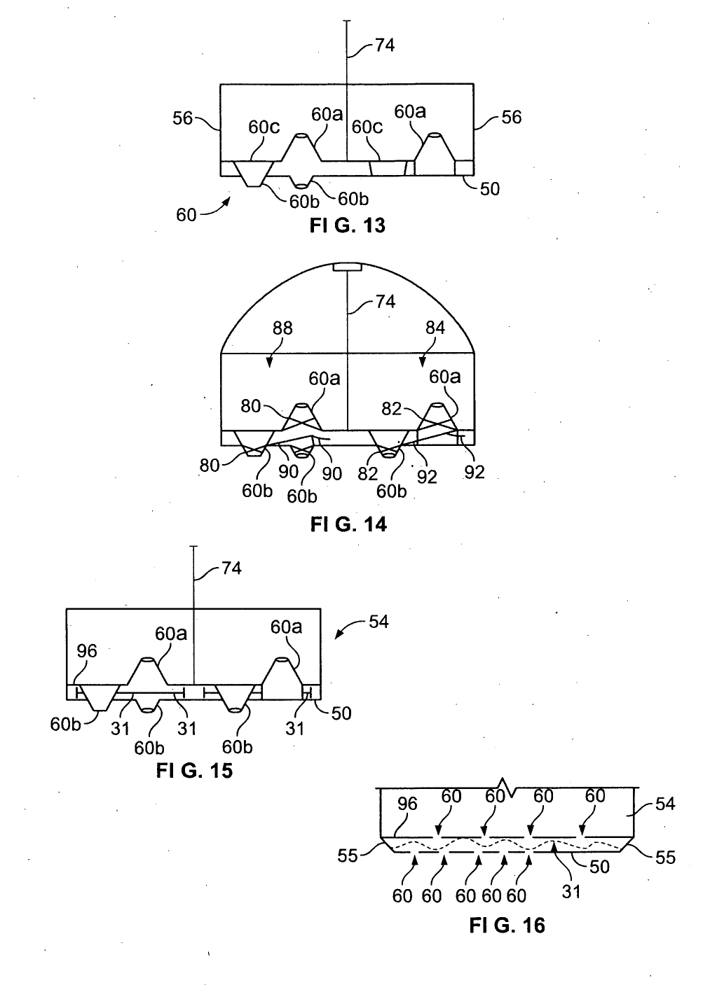

The face 50 may be formed with a plurality of dispensing aperture assemblies, generally illustrated as 60, where through fluid passes to come in contact with a portion of a human body. The dispensing aperture assemblies 60 (see FIGS. 5A-5C) may be in the form of an upper dispensing cone 60a, or a lower dispensing cone 60b, or an aperture 60c, or any combination of the foregoing, such as illustrated in FIGS. 12 and 13. In another embodiment of the invention, a support platform 96 may be disposed in the body 54 at a distance from the face 50 such as to form a cavern 99 between the face 50 and the support platform 96. The support platform 96 may be formed with a plurality of dispensing aperture assemblies, generally illustrated as 96, where through fluid 64 passes to enter the cavern 99 for subsequent dispensing through one or more of the dispensing aperture assemblies 60. The dispensing aperture assemblies 98 (see FIGS. 5A-5C) may be in the form of any suitable dispensing aperture assemblies 98, such as any of the previously mentioned dispensing aperture assemblies 60 (e.g., upper dispensing cone 60a, or a lower dispensing cone 60b, or an aperture 60c, or any combination of the foregoing). Fluid 64 may be any suitable fluid, such as shampoo, conditioner, body soap or moisturizers. The fluid 64 may be placed in the hollow body 54 of the head assembly 14 in pure or free-flowing form (such as by pouring from a suitable container containing the fluid, such as a shampoo container) or the fluid 64 may be placed in the hollow body 54 through the use of replaceable bags, generally illustrated as 100. The bag 100 has an adhesive section 102. In one embodiment of the invention, the bag 100 has a plurality of apertures 106 which is normally releasably covered by the adhesive section 102 as illustrated in FIG. 7. For this embodiment of the invention, after the adhesive section 102 is peeled back to expose the apertures 106, the bag 100 is placed within the hollow body 54 with the apertures 106 faced towards the face 50 or towards the support platform 96. Fluid 64 would leave the bag 100 through the apertures 106. In another embodiment of the invention, the bag 100 has an adhesive section 110 which includes at least one aperture 114. A flap 118 is releasably disposed on the adhesive section 110 to cover the aperture 114. When the flap 118 is pulled off of the adhesive section 110 to expose the aperture 114, a dispensing cone assembly (e.g., dispensing cone assembly 60a) dispensing cone assembly may be inserted through the aperture 114, as best shown in FIG. 11. The adhesive section 110 may be used to firmly secure the bag 100 to the support platform 96 and/or around the dispensing cone assembly, as also best shown in FIG. 11. Fluid 64 flows out of bag 100, through the dispensing cone assembly dispensing cone assembly supported by support platform 96, and into the cavern 99 for subsequent dispensing through the dispensing aperture assemblies 60 in the face 50 of the head assembly 14.

In another embodiment of the invention the body 54 is formed with two or more compartments, such as compartments 84 and 88. A cover assembly, generally illustrated as 68, covers the compartments 84 and 88. Cover assembly 68 includes detachable (or pivotally connected compartments) compartment cover 68a and 68b for respectively covering compartments 84 and 88. A partition member 74 is connected to the body 54 and to the face 50 (or to the support platform 96 for another embodiment) for support thereby. The partition member 74 separates compartments 84 and 88. Compartment cover 68a and 68b releasably connect to each other. A recess 70 including recess parts 70a and 70b are conveniently situated between the compartment covers 68a and 68b for respectively providing openings for a human finger to lodge to pull apart releasably connected compartment covers 68a and 68b for allowing access to compartments 84 and 88, as best shown in FIG. 6, which is a top plan view of the embodiment of the head assembly 14 of the electrical hair brush and/or body washer 10 in FIG. 6B after the two compartment cover 68a and 68b have been respectively removed from and/or off of the two compartments 84 and 88, exposing the insides of the two compartments 84 and 88 including a plurality of holes or fluid dispensing cone assemblies 60 where through fluid 64 from the compartments exits.

Referring now to FIGS. 1 and 14 for illustrating other embodiments of the invention, the handle assembly 18 includes two buttons, button 160 and button 170. The latter button 170 controls the speed of movement and/or vibration of the head assembly 14 (and/or the face 50). Button 170 may operate as a rheostat such that as button 170 is slid in direction of the arrow in FIG. 1, the vibration/movement of the head assembly 14 is initially activated and then subsequently increases in vibration/movement as the button 170 continues to slide.

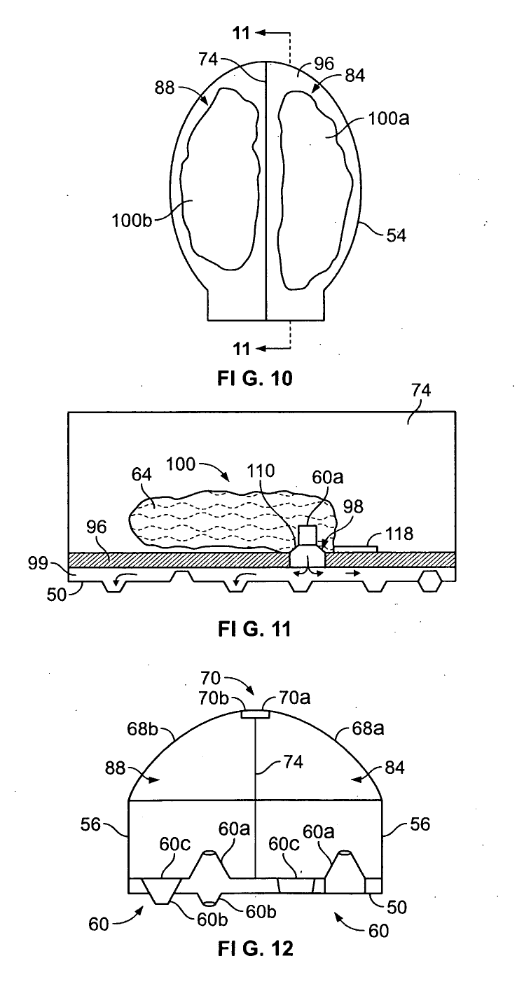

Button 160 has positions 1, 2 and 3. When button 160 is in position 1, after button 170 has activated movement and/or vibration of the head assembly 14, valves 80 within dispensing cone assemblies 60 (see FIG. 14) are opened to release fluid 64 from compartment 84. As previously indicated, the dispensing cone assemblies 60 may be situated in the face 50 and/or in the support platform 96. Valves 80 are controlled by current passing through wires 90 from the battery 24. When button 160 is in position 2, after button 170 has activated movement and/or vibration of the head assembly 14, valves 82 within dispensing cone assemblies 60 (see FIG. 14) are opened to release fluid 64 from compartment 88. Valves 82 are controlled by current passing through wires 92 from the battery 24. When button 160 is in position 3, after button 170 has activated movement and/or vibration of the head assembly 14, both valves 80 and 82 within dispensing cone assemblies 60 (see FIG. 14) are opened to release fluid 64 from compartments 84 and 88. As previously suggested, compartments 84 and 88 may each have different fluid. One of the compartments may have shampoo, while the other compartment has conditioner. For example, and as illustrated in FIG. 10, bags 100a and 100b respectively contain different fluids. It is understood and is readily apparent that between battery 24 and the respective valves 80 and 82 are the appropriate hardware (e.g., gates, etc) and/or software (e.g., source code, processor, etc) for opening and closing valves 80 and 82 as desired and in accordance with the lodged position of button 170. The hardware and/or software would control the amount of current flowing through wires 90 and 92 from the battery 24 so the flow of fluid 64 through valves 80 and 82 is controlled.

Practice of various embodiments of the present invention provides an electrical hairbrush and body washer having ultrasonic movements, and a plurality of compartments for containing and releasing different fluids, such as shampoo, conditioner, body soap and moisturizers. An engine is located in a handle. The engine in the handle may operate off of a rechargeable battery. The electrical hairbrush and body washer functions similar to an ultrasonic toothbrush, which can be found over the counter. The handle may latch to different heads. Various buttons or switches are provided for controlling the speed of ultrasonic movements and control which fluids are being released from their associated compartments. Each head may have a different function and may come in different sizes. The electrical hairbrush and body washer may also come with disposable or reusable containers and/or bags for different fluids, such as shampoo, conditioner, body soap, and moisturizer. The head has a plurality of holes where the fluid(s) will be dispensed in accordance with the different buttons that may be used. The electrical hairbrush and body washer will be water resistance and may be used safely in the shower.

The operation of the ultrasonic hairbrush could be similar to the ultrasonic toothbrush in its engine, movement and quality of the bristles. In one embodiment of the invention, there will be no rotation of the bristles but instead there will be a gentle vibration or sonic movement so hair will not get strangled and pulled. One will use the brush in a normal manner with the various buttons having different functions. One of the buttons may conveniently control the speed of the movement of the bristles or the scrub, which may have different levels, fast, moderate or slow. The user may conveniently increase or decrease the motion of the bristles or the scrub force by the buttons. The heads of the brush are exchangeable with the body scrub and massage heads. Different heads will come in different sizes to serve their purposes according to the user's desire. The bags for being disposed in the various compartments may be disposable. The user can switch from one fluid to another, or can commingle fluids, by pressing the appropriate corresponding button and the holes (i.e., valves in the conical shaped fluid-dispensing assemblies) of that particular compartment will open.

Reference throughout this specification to “one embodiment”, “an embodiment”, or “a specific embodiment” means that a particular feature, structure, or characteristic described in connection with the embodiment is included in at least one embodiment of the present invention and not necessarily in all its embodiments. Therefore, the respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of the illustrated embodiments of the present invention and are to be included within the spirit and scope of the present invention.

Therefore, while the present invention has been described herein with reference to the particular embodiments thereof, a latitude of modification, various changes and substitutions are intended in the foregoing disclosures, and it will be appreciated that in some instances some features of the embodiments of the invention will be employed without the corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for washing comprising: providing an electrical vibrating device having a handle assembly coupled to a detachable head assembly; dispensing at least one fluid from the head assembly for washing.

2. The method of claim 1 additionally comprising vibrating at least one part of the head assembly of the electrical vibrating device.

3. The method of claim 1 wherein said dispensing at least one fluid comprises dispensing a first fluid from the head assembly, and dispensing a second fluid from the head assembly, said second fluid being different than said first fluid.

4. The method of claim 1 additionally comprising controlling the rate that said at least one fluid is dispensed from the head assembly.

5. The method of claim 3 additionally comprising controlling the dispensing of the first fluid and of the second fluid.

6. The method of claim 4 wherein said controlling comprises controlling the rate of flow of the fluid through at least one dispensing cone assembly supported by the head assembly.

7. The method of claim 2 wherein said part of the head assembly is a face flexibly coupled to a body of the head assembly and having a plurality of apertures for dispensing the fluid.

8. The method of claim 6 wherein said dispensing cone assembly is selected from the group consisting of an upper cone assembly, a lower cone assembly, and a combination of an upper cone assembly and a lower cone assembly.

9. The method of claim 6 wherein said dispensing cone assembly comprises a valve for controlling the flow of fluid through the dispensing cone assembly.

10. The method of claim 9 wherein said controlling the flow of fluid comprises engaging a button on the handle assembly to control current to the valve from a battery contained in the handle assembly.

11. The method of claim 1 wherein said detachable head assembly comprises a body having a plurality of compartments, a plurality of compartment lids releasably secured over the compartments, a support platform defining the bottom on the compartments, and a face secured to the body and spaced from the support platform to provide a cavern between said support platform and said face, said support platform including at least one dispensing cone assembly for each compartment and said face have at least one dispensing aperture.

12. The method of claim 11 additionally comprising a first fluid bag secured to the dispensing cone assembly in one of the compartments for releasing fluid through the dispensing cone assembly secured to the first fluid bag, and a second fluid bag secured to the dispensing cone assembly in another compartment for releasing fluid through the dispensing cone assembly secured to the second fluid bag.

13. An electrical vibrating device having a handle assembly coupled to a detachable head assembly, said head assembly comprising a body having a plurality of compartments, a plurality of compartment lids releasably secured over the compartments, a support platform defining the bottom on the compartments, and a face secured to the body and spaced from the support platform to provide a cavern between said support platform and said face, said support platform including at least one dispensing cone assembly for each compartment and said face have at least one dispensing aperture.

14. The device of claim 13 additionally comprising a first fluid bag secured to the dispensing cone assembly in one of the compartments for releasing fluid through the dispensing cone assembly secured to the first fluid bag, and a second fluid bag secured to the dispensing cone assembly in another compartment for releasing fluid through the dispensing cone assembly secured to the second fluid bag.

15. The device of claim 13 wherein said face comprises a plurality of knobs supporting bristles.
